(19) United States
(12) Patent Application Publication
(10) Pub. No.: US 2012/0329683 A1
(43) Pub. Date: Dec. 27, 2012

(54) DEGRADABLE FIBER SYSTEMS FOR WELL TREATMENTS AND THEIR USE

(76) Inventors: Nicolas Droger, Novosibirsk (RU); Vladimir Sergeevich Bugrin, Novosibirsk (RU); Diankui Fu, Novosibirsk (RU); Sergey Mihailovich Makarychev-Mikhailov, Novosibirsk (RU); Vadim Kamil'evich Khlestkin, Novosibirsk (RU)

(21) Appl. No.: 13/167,213

(22) Filed: Jun. 23, 2011

(51) Int. Cl. C09K 8/80

(52) U.S. Cl. 507/219

(57) ABSTRACT

A method for treating a subterranean formation penetrated by a wellbore is carried out introducing a treatment fluid into the formation through the wellbore wherein the formation has a formation temperature of at least 70° C. A composition for such treatment is also provided. The composition and treatment fluid for the method is formed from water and an amount of fibers formed from high temperature polymers of at least one of a polyester, polyamide, polyurethane, polyurea polymers, and copolymers of these. Each of said high temperature polymers is characterized by the property of not substantially degrading in water at a pH of from 5 to 9 at temperatures below 80° C. A fiber degrading accelerant that facilitates degrading of the fibers at the formation temperature is also included in the treatment fluid.

### FIELD

This invention relates to compositions and methods for treating subterranean formations with materials that include a fiber component.

### BACKGROUND

The statements made in this section merely provide information related to the present disclosure and may not constitute prior art, and may describe some embodiments illustrating the invention.

Degradable fiber materials have been used in many oilfield applications for the transportation of proppants, diversion of hydraulic fracturing and in carbonate acidizing. More recently, fiber materials have been used in lost circulation during drilling operations.

Polylactic acid (PLA) has been the fiber of choice in most of these applications because of its desired degradation and mechanical properties. Polylactic acid is also readily available and more cost effective to use compared to other degradable materials. Polylactic acid, however, has an upper temperature limit of about 100° C., above which PLA fibers tend to quickly degrade. Examples of such degradable polymer systems are those described in U.S. Pat. Nos. 7,275,596; 7,380,600; 7,380,601; 7,565,929, and in European Patent No. 1556458.

Accordingly, there is a need to provide a degradable fiber systems that can be used at temperatures where known fiber systems have not been successfully employed.

### SUMMARY

A method of treating a subterranean formation penetrated by a wellbore is performed by introducing a treatment fluid into the formation through the wellbore wherein the formation has a formation temperature surrounding the wellbore of at least 70° C. The treatment fluid is comprised of water and an amount of fibers formed from high temperature polymers of at least one of a polyester, polyamide, polyurethane, and polyurea, and copolymers of these materials. Each of said high temperature polymers is characterized by the property of not substantially degrading in water at a pH of from 5 to 9 at temperatures below 80° C. The treatment fluid further comprises a fiber degrading accelerant that facilitates degrading of the fibers at the formation temperature.

In specific embodiments, the high temperature polymers may be selected from at least one of nylon 6, nylon 6,6, nylon 6,12, nylon 11, polypeptides, polyurethane, polyurea, polyethylene terephtalate, polyhydroxycarboxylic acids, polyaminoacids, and copolymers of these.

In certain applications, at least one of (1) to (4) may be true, wherein (1) is the fiber degrading accelerant is formed from a material that is mixed in the treatment fluid with the fibers and that releases the fiber degrading accelerant within the treatment fluid over a period of at least one hour when at the formation temperature: (2) is the fiber degrading accelerant is incorporated with at least some of the fibers; (3) is the fiber degrading accelerant is encapsulated within an encapsulating material; and (4) is the fiber degrading accelerant is formed as a degrading polymer that degrades at the formation temperature.

The fiber degrading accelerant may be formed in certain cases as a degrading polymer that readily degrades at the formation temperature to release fiber degrading materials, the degrading polymer being coextruded with the high temperature polymers to form the fibers. The fiber degrading accelerant may form a core of the fibers, with the high temperature polymers surrounding the core.

The fiber degrading accelerant may be formed from at least one of (1) to (4), wherein (1) is a base selected from at least one of calcium hydroxide, calcium oxide, magnesium hydroxide, magnesium oxide and zinc oxide; (2) is an acid selected from at least one of oleic acid, benzoic acid, nitrobenzoic acid, stearic acid, uric acid, fatty acids, and derivatives of these; (3) is an oxidizer selected from at least one of a bromate, a persulfate, a nitrate, a nitrite, a chlorite, a hypochlorite, a perchlorite, and a perborate; and (4) is a polymer selected from at least one of polymers and copolymers of lactic acid, glycolic acid, vinyl chloride, phthalic acid, and combinations of these.

In certain embodiments, the fiber degrading accelerant may be used with the high temperature polymer in weight ratio of from about 1:1 to about 1:100. The treatment fluid may further comprises a proppant. The fiber degrading accelerant may be selected so that it does not form a diacid.

The invention also includes a composition for use in treating a well of a subterranean formation having a formation temperature of at least 70° C. The composition comprises water and an amount of fibers formed from high temperature polymers of at least one of a polyester, polyamide, polyurethane, polyurea, and copolymers of these materials. Each of the high temperature polymers is characterized by the property of not substantially degrading in water at a pH of from 5 to 9 at temperatures below 80° C. The composition further comprises a fiber degrading accelerant that facilitates degrading of the fibers at the formation temperature.

In specific embodiments of the composition, the high temperature polymers may be selected from at least one of nylon 6, nylon 6,6, nylon 6,12, nylon 11, polypeptides, polyurethane, polyurea, polyethylene terephtalate, polyhydroxycarboxylic acids, polyaminoacids, and copolymers of these.

In certain compositions, at least one of (1) to (4) may be true, wherein (1) is the fiber degrading accelerant is formed from a material that is mixed in the treatment fluid with the fibers and that releases the fiber degrading accelerant within the treatment fluid over a period of at least one hour when at the formation temperature: (2) is the fiber degrading accelerant is incorporated with at least some of the fibers; (3) is the fiber degrading accelerant is encapsulated within an encapsulating material; and (4) is the fiber degrading accelerant is formed as a degrading polymer that degrades at the formation temperature.

The fiber degrading accelerant may be formed in certain cases as a degrading polymer that readily degrades at the formation temperature to release fiber degrading materials, the degrading polymer being coextruded with the high temperature polymers to form the fibers. The fiber degrading accelerant may form a core of the fibers, with the high temperature polymers surrounding the core.

The fiber degrading accelerant may be formed from at least one of (1) to (4), wherein (1) is a base selected from at least one of calcium hydroxide, calcium oxide, magnesium hydroxide, magnesium oxide and zinc oxide; (2) is an acid selected from at least one of oleic acid, benzoic acid, nitrobenzoic acid, stearic acid, uric acid, fatty acids, and derivatives of these; (3) is an oxidizer selected from at least one of a bromate, a persulfate, a nitrate, a nitrite, a chlorite, a hypochlorite, a perchlorite, and a perborate; and (4) is a polymer selected from at least one of polymers and copolymers of lactic acid, glycolic acid, vinyl chloride, phthalic acid, and combinations of these.

In certain embodiments of the composition, the fiber degrading accelerant may be used with the high temperature polymer in weight ratio of from about 1:1 to about 1:100. The treatment fluid may further comprises a proppant. The fiber degrading accelerant may be selected so that it does not form a diacid.

### BRIEF DESCRIPTION OF THE DRAWINGS

For a more complete understanding of the present invention, and the advantages thereof, reference is now made to the following descriptions taken in conjunction with the accompanying figures, in which:

FIG. 1 is a plot of the degradation rate of nylon 6 in water at 130° C. as a function of time used without any fiber degrading accelerant;

FIG. 2 is a plot of the degradation rate of nylon 6 in water at 130° C. as a function of time using different amounts of Ca(OH)₂;

FIG. 3 is a plot of the degradation rate of nylon 6 in water at 130° C. as a function of time using different amounts of benzoic acid;

FIG. 4 is a plot of the degradation rate of nylon 6 in water at 80° C. and 130° C. as a function of time using different amounts of encapsulated NaBrO₃;

FIG. 5 is a plot of the degradation rate of nylon 6 in water at 80° C. and 130° C. as a function of time using encapsulated sodium persulfate;

FIG. 6 is a plot of the degradation rate of nylon 6 in water at 130° C. as a function of time using different forms and amounts of polylactic acid (PLA);

FIG. 7 is a plot of the amount of degradation of various cellulose fiber materials using a cellulase enzyme for five days in water at 120° F. (48.9° C.);

FIG. 8 is a plot of the degradation rate of various Rayon fiber materials using a cellulase enzyme for five days in water at 100° F. (37.8° C.) over time;

FIG. 9 is a plot of the amount of degradation of Rayon fiber materials using a fresh cellulase enzyme and cellulose enzyme kept at a pH of 9 for 24 hours when used for three days in water at 120° F. (48.9° C.) at neutral pH of 7 and at a pH of 9; and

FIG. 10 is a plot of the amount of degradation of milk and soybean protein fiber using a protease enzyme for three days in water at 120° F. (48.9° C.).

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

Embodiments of the present invention are directed toward degradable fibers for use in oil and gas wells. In one aspect, degradable fibers may be selected for use where the formation temperature of the wells exceeds 65° C., 70° C., 80° C., 90° C., 100° C., 110° C., 120° C., 130° C., 140° C., 150° C., 160° C., 170° C., 180° C., 190° C., 200° C., or more. Certain high temperature polymers formed from polyester, polyamide, polyurethane and polyurea materials and copolymers of these materials that are characterized by the property of not substantially degrading in water at a pH of from 5 to 9, more particularly at a pH of about 7, below temperatures of 70° C., 80° C., 90° C., 100° C., 110° C., 120° C. or 130° C. can be used in forming degradable fiber systems for use in high temperature applications. These temperatures may be de dependent upon the particular application. For instance, in stimulation applications the system may be designed to not substantially degrade below 120° C. For lost circulations applications, the system may be configured to not substantially degrade below a temperature of 70° C. As used herein, the expression “not substantially degrading” or similar expressions used herein with respect to the high temperature polymers is meant to encompass those materials that exhibit less than 2% weight loss after 1 week in water at selected temperature and pH conditions. As used herein, the expression “high temperature polymer” and similar expressions should be distinguished from the biopolymers of the biopolymer fiber systems that are employed with enzymes that are discussed later on unless otherwise stated or is apparent from the particular context.

Examples of suitable high temperature polymers formed from polyester and polyamide materials include polyethylene terephthalate (PET), nylon 6,6, nylon 6 (polycaprolactam), nylon 11, nylon 6,12, and natural polyamides, such as polypeptides. Polyurethanes and polyureas and their copolymers (e.g. Spandex®) may also be used. The polyester, polyamide, polyurethane and polyurea polymer materials may be used as homopolymers or as copolymers of two or more of the monomer or polymer constituents forming these polymers.

In certain applications, high temperature polymers that are not based on diacids may be used. Such materials may degrade to form byproducts that may be sensitive to the composition of the formation fluids they encounter. For example, PET and nylon 6,6 both degrade or hydrolyze into diacids. Formations where divalent or multivalent ions, such as Ca²⁺ and Mg²⁺ cations, are present may tend to react with the formed diacids and precipitate out of solution. Therefore, in instances where polyvalent ions may be present, polymers that do not form such diacids may be used. These may include those materials formed from polyhydroxycarboxylic acids, polyaminoacids, and copolymers of these materials, such as nylon 6 and nylon 11.

The high temperature polymer fibers may have a variety of configurations. As used herein, the term “fiber” is meant to include fibers as well as other particulates that may be used as or function similarly to fibers for the purposes and applications described herein, unless otherwise stated or as is apparent from its context. These may include various elongated particles that appear as fibers or are fiber-like. The fibers or particulates may be straight, curved, bent or undulated. Other non-limiting shapes may include generally spherical, rectangular, polygonal, etc. The fibers may be formed from a single particle body or multiple bodies that are bound or coupled together. The fibers may be comprised of a main particle body having one or more projections that extend from the main body, such as a star-shape. The fibers may be in the form of platelets, disks, rods, ribbons, etc. The fibers may also be amorphous or irregular in shape and be rigid, flexible or plastically deformable. Fibers or elongated particles may be used in bundles. A combination of different shaped fibers or particles may be used and the materials may form a three-dimensional network within the fluid with which they are used. For fibers or other elongated particulates, the particles may have a length of less than about 1 mm to about 30 mm or more. In certain embodiments the fibers or elongated particulates may have a length of 12 mm or less with a diameter or cross dimension of about 200 microns or less, with from about 10 microns to about 200 microns being typical. For elongated materials, the materials may have a ratio between any two of the three dimensions of greater than 5 to 1. In certain embodiments, the fibers or elongated materials may have a length of greater than 1 mm, with from about 1 mm to about 30 mm, from about 2 mm to about 25 mm, from about 3 mm to about 20 mm, being typical. In certain applications the fibers or elongated materials may have a length of from about 1 mm to about 10 mm (e.g. 6 mm). The fibers or elongated materials may have a diameter or cross dimension of from about 5 to 100 microns and/or a denier of about 0.1 to about 20, more particularly a denier of about 0.15 to about 6.

The high temperature polymers used in forming the degradable fibers are used in conjunction with a fiber degrading accelerant. The fiber degrading accelerant facilitates degrading of the fibers at those temperatures in which the high temperature polymer fibers are used and can be any material that facilitates such degradation. The particular fiber degrading accelerant may be selected, designed and configured to provide a selected degradation rate at selected temperatures and conditions in which the fibers are to be used. For example, the fiber degrading accelerant may facilitate providing a fiber degradation rate of about 20%, 30%, 40%, 50%, 60%, 70%, 80%, 90% up to 100% fiber degradation by weight or less over a period of from about 1 day to about 30 days at downhole temperature conditions. In certain applications, a degradation rate of from about 20% to about 40% by weight over a period of from about 1 day to about 30 days at downhole temperature conditions may be particularly useful. Typically, the fiber degrading accelerant will be a pH adjusting material, such as a base, an acid, or a base or acid precursor that forms bases or acids in situ. The fiber degrading accelerant may also be an oxidizer.

Those bases for use as the fiber degrading accelerant can be any base or base precursor that facilitates the desired controlled degradation of the high temperature polymer fibers under the conditions in which the fibers are employed. The base may be one that that provides a pH of about 11 or 12 or more in the fluids or environment surrounding the high temperature polymer fibers. The base may be that provided from a low solubility oxide or hydroxide that slowly dissolves in aqueous fluids used with the fibers at the formation temperatures for which the polymer fibers are employed. Non-limiting examples of such low solubility bases include calcium hydroxide, calcium oxide, magnesium hydroxide, magnesium oxide, zinc oxide, and combinations of these. In cases where the bases produce polyvalent ions, such as Ca²⁺ and Mg²⁺, it may be desirable to use fibers that do not degrade to form diacids, as discussed previously, such as nylon 6 and nylon 11. Bases that have higher solubility, such as sodium hydroxide, potassium hydroxide, barium hydroxide (Ba(OH)₂), lithium hydroxide (LiOH), rubidium hydroxide (RbOH), caesium hydroxide (CsOH), and combinations of these, may also be used provided their effect on the high temperature polymers provides the desired delay or controlled degradation of the fibers. This may be facilitated by encapsulation or the use of other delayed release techniques.

The acids employed as the fiber degrading accelerant may be any acid or acid precursor that facilitates the desired controlled degradation or hydrolysis of the high temperature polymer fibers under the conditions in which the fibers are employed. These may be Lewis acids or Bronsted acids. The acid may provide a pH of about 3 or less in the fluids or environment surrounding the high temperature polymer fibers. The acid may be a low solubility acid that slowly dissolves in aqueous fluids used with the fibers at the formation temperatures. Non-limiting examples of such low solubility acids may include oleic acid, benzoic acid, nitrobenzoic acid, stearic acid, uric acid, fatty acids, and derivatives of these, and their combinations. Other acids having higher solubility, such as hydrochloric acid, citric acid, acetic acid, formic acid, oxalic acid, maleic acid, fumaric acid, etc. Other soluble organic acids may also be used. Such soluble acids may also be used provided their effect on the high temperature polymers provides the desired delay or controlled degradation of the fibers. This may be facilitated by encapsulation or the use of other delayed release techniques. Lewis acids of BF₃, AlCl₃, FeCl₂, MgCl₂, ZnCl₂, SnCl₂, and CuCl₂ may be also used.

Oxidizers may also be used as the fiber degrading accelerant. Oxidizers may have unique properties that may cause them to have dual functions. Non-limiting examples of suitable oxidizers include bromates, persulfates, nitrates, nitrites, chlorites, hypochlorites, perchlorites, and perborates, and combinations of these. Specific non-limiting examples of these materials include sodium bromate, ammonium persulfate, sodium nitrate, sodium nitrite, sodium chlorite, sodium hypochorite, potassium perchlorite, and sodium perborate. At temperatures where the oxidative half-life is sufficient, the oxidizers act as oxidizers and degrade the high temperature polymers through oxidation. At higher temperatures where their oxidative half-life is short, they may be reduced (generally by water) and turn into their acidic counterpart, thus lowering the fluid pH so that they create a pH-induced hydrolysis of the polymers. Thus, for example, persulfate may be reduced to sulfuric acid, which then hydrolyzes the polymers. The oxidizers may be selected to have low solubility in the aqueous fluids used with the high temperature polymer fibers at the temperatures the fibers are used. In other embodiments, the oxidizers may be readily soluble in such fluids but may be encapsulated or used with other delayed release techniques to delay or control release of the oxidizer.

Another fiber degrading accelerant includes other degradable polymers. The degradable polymers used as the fiber degrading accelerant are characterized in that they degrade more readily than the high temperature polymers at certain conditions, such as lower temperature, and they facilitate the degradation of the high temperature fibers. Such degradable polymers may degrade at a rate of at least 10 times faster than the high temperature polymers at the same environmental conditions. The degradation of the polymer may include degradation of the polymer into species that facilitate the degradation of the high temperature polymer fibers. These may be “polymeric acid precursors” that are typically solids at room temperature. The polymeric acid precursor materials may include the polymers and oligomers that hydrolyze or degrade in certain environments under known and controllable conditions of temperature, time and pH to release acids. The acids formed from such polymers may be monomeric acids but may also include dimeric acid or acid with a small number of linked monomer units that function similarly, for purposes of embodiments of the invention described herein, to monomer acids composed of only one monomer unit.

Non-limiting examples of such degradable polymers for use of the fiber degrading accelerant include polymers and copolymers of lactic acid, glycolic acid, vinyl chloride, phthalic acid, etc., and combinations of these. The degradable polymer acid precursors may include those that are described in U.S. Pat. Nos. 7,166,560; 7,275,596; 7,380,600; 7,380,601; 7,565,929, and in European Patent No. 1556458, each of which is incorporated herein by reference for all purposes. Polylactic acid (PLA) and polyglycolic acid (PGA) degrade to form the organic acids of lactic acid and glycolic acid, respectively. Polyvinyl chloride (PVC) degrades to form the inorganic acid of hydrochloric acid. Examples of degradable PVC materials may include those described in Lu, J., Shibai Ma, and Jinsheng Gao, Study on the Pressurized Hydrolysis Dechlorination of PVC. Energy & Fuels, 2002. 16(5): p. 1251-1255, which is incorporated herein by reference in its entirety for all purposes. Phthalic acid polymer materials may include polymers of terephthalic and isophthalic acid. Polyester and polyamide materials formed from diacids that degrade into acids at the desired rate and environmental conditions to form the fiber degrading accelerant may also be used.

The fiber degrading accelerant may be used with the high temperature polymer fibers in a number of different ways. In one embodiment, the accelerant is formed from a material that is merely intermixed in the treatment fluid or portion thereof with the high temperature polymer fibers and is selected to slowly release the fiber degrading accelerant within the treatment fluid in contact with the surrounding high temperature polymer fibers over time when at the temperature in which the high temperature polymers are to be employed, such as those formation temperatures previously discussed. Such fiber degrading accelerant materials are not encapsulated and may be selected so that they release the fiber degrading accelerant within the treatment fluid over a period of at least one (1) hour when at the formation temperature, more particularly from about one (1) hour to about 14 hours, still more particularly from about one (1) hour to about one (1) day. Such materials may include slowly dissolving bases, acids, oxidizers, and their precursors, such as the polymeric acid precursors, as has been discussed previously. The materials may be configured as solid particles, which may be granules, fibers and other particulate shapes and configurations. The size and shape may also facilitate the rate of release of the accelerant. For example, larger particle sizes and particles with smaller surface area may provide longer release times than smaller particles or those with larger surface areas. A combination of different sized and configured particles may also be used. Those degradable polymers formed from polymeric acid precursors previously discussed that are more readily degraded at the formation temperatures and form acids useful as a fiber degrading accelerant may be used and formed into fibers that are used in combination with the high temperature polymer fibers. Such fibers may be sized, shaped and configured the same or similarly as discussed previously with respect to the high temperature polymer fibers.

In another embodiment, the fiber degrading accelerant materials are incorporated into the high temperature polymer fibers themselves. This may be accomplished through mixing, blending or otherwise compounding the fiber degrading accelerant materials with the base polymer used to form the high temperature polymer fibers before the polymers are extruded or otherwise formed into fibers. This may include any of the fiber degrading accelerant materials previously discussed provided they are capable of being mixed, blended or compounded with the base polymers prior to extrusion or the formation of the fibers. The additive materials to the fibers may be substantially uniformly distributed throughout the individual fiber matrix in this manner. Alternatively, the additive may be non-uniformly distributed throughout the fiber. Incorporating the fiber degrading accelerant into the fiber ensures that the degrading accelerant remains with the fibers in the treatment fluid and contributes to their degradation once in place. Particularly well suited for this application are the low temperature degradable polymer materials previously discussed above. In certain instances, the fiber degrading accelerant may be incorporated with the fiber by applying the degrading accelerant as a coating that is applied to the already formed high temperature polymer fibers.

In still another application, an encapsulating material may be used with the fiber degrading accelerant. The encapsulation allows for the controlled release of the active substance. In this way, degrading materials that are more active or cause more rapid degradation of the fiber materials may be used as the encapsulation contributes to the slow or delayed release of such materials. This may include acids, bases, oxidizers or other degrading accelerants that are more soluble in the aqueous fluids at the temperatures for which the high temperature polymers are used. Less soluble or slowly soluble materials may also be encapsulated, however. The encapsulating material may be selected and configured to provide the desired delay or controlled release of the fiber degrading accelerant. Different types of encapsulating materials may be used with the same or different accelerants. The encapsulated materials may also have different sizes and configurations.

U.S. Pat. No. 4,741,401, which is hereby incorporated by reference in its entirety for all purposes, provides examples of suitable encapsulation techniques and materials. As an example of an encapsulated degrading accelerant, oxidizers such as sodium bromate or diammonium peroxidisulhate may be encapsulated in copolymers of vinylidene chloride and methyl acrylate using the methods described in the above-referenced patent.

In use, the encapsulated accelerant is intermixed in the treatment fluid or portion thereof with the high temperature polymer fibers. Incorporated with the fiber system, the encapsulated degrading accelerant may be released in a delayed and progressive fashion, allowing a controlled and continuous degradation of the polymer fibers. The encapsulating enclosure may be selected and configured so that it releases the fiber degrading accelerant within the treatment fluid over a period of at least one (1) hour when at the formation temperature, more particularly from about one (1) hour to about 14 hours, still more particularly from about one (1) hour to about one (1) day. Such delay may also be provided by the degree of solubility of the encapsulated material. Thus, the desired control and delay may therefore be affected by a combination of the encapsulating material and the accelerant material itself.

In another embodiment, the high temperature polymer fibers are formed as bi- or multi-component fibers with other degradable polymers, such as those previously described. In such instances, the polymers are not blended or compounded together prior to extrusion but are coextruded or formed separately as separate components of the same fiber. This may accomplished, for example, by coextrusion where separate streams of each polymer component is directed from a supply source through a spinning head (often referred to as a “pack”) in a desired flow pattern until the streams reach the exit portion of the pack (i.e. the spinnerette holes) from which they exit the spinning head in the desired multi-component relationship. The formation of multi-component polymer fibers is described in U.S. Pat. No. 6,465,094, which is herein incorporated in its entirety for all purposes. The various components of the multi-component fibers may be arranged and configured in a variety of different configurations, such as sheath-core fibers with single or multiple cores, different layers, etc. Either of the high temperature polymer or the degradable polymer fiber degrading accelerant may be used as the core or sheath. In certain embodiments, the degradable polymer degrading accelerant forms the core or cores, with the high temperature polymer forming the sheath or outer layer. The multi-component fibers may be configured in the same overall shapes, sizes and configurations to those fibers previously described.

The amounts of fiber degrading accelerant used with any of the embodiments described may vary and may depend upon a variety of factors. These may include the specific environmental conditions of use (e.g. formation temperature, fluid pH, etc.), the type of accelerant used and its activity, the type of high temperature polymer used, etc. Typically, the amount of fiber degrading accelerant used with the high temperature polymer fibers being degraded will range in a weight ratio from about 2:1 to about 1:100 of accelerant to high temperature polymer, more particularly from 1:1 to about 1:20, and more particularly from about 1:2 to about 1:10. Thus, for example, a weight ratio of 1:1 for the accelerant/high temperature fiber may be used within the treatment fluid or the accelerant may compose 50% by weight of the fibers themselves, such as when it is incorporated into the high temperature polymer fiber or coextruded with the fibers to form multi-component fibers.

Any of the above-described techniques may be used for the delayed or controlled degradation of the high temperature polymer fibers. A combination of any or all of these techniques may be used in any given treatment as well.

The degradable high temperature polymer fiber systems described herein may be used for a variety of different applications where temporary fiber systems have been used in oil and gas well construction and stimulation at lower temperatures. In particular, the fiber systems may be used in wells where the formation temperatures of the well or those temperatures where the fibers are to be used may be from about 65° C., 70° C., 80° C., 90° C., 100° C., 110° C., 120° C., 130° C., 140° C., 150° C., 160° C., 170° C., 180° C., 190° C., 200° C. or more.

The fiber systems may be used as temporary or degradable materials for well construction, stimulation, fluid diversion, bridging, plugging, zone isolation, etc. The fiber system may be used to facilitate the transportation and placement of proppants and other materials, for gas phase stabilization, etc. They may be used for diversion in hydraulic fracturing, in carbonate acidizing, and in lost circulation during drilling. Non-limiting examples of the use of fibers and fluid systems employed with fibers are described in U.S. Pat. Nos. 7,275,596; 7,380,600; 7,380,601; 7,565,929, and in European Patent No. 1556458.

Where the high temperature polymers are mixed together in a fluid, they may be mixed on the fly or in a batch and introduced into the wellbore of the formation being treated. They may also be premixed and stored where temperatures do not facilitate dissolution or degrading of the materials to form the fiber degrading accelerant within the stored fluid.

The fluids employed with the fiber systems may be aqueous fluids formed from fresh water, sea water, brine, etc. The fluids employing the degradable high temperature fiber system may include other components and additives such as those that are commonly used in oil and gas well construction and stimulation, particularly those that may be used at high temperatures. Such components may gelling agents, crosslinkers, proppants, fluid loss additives, weighting agents, lost circulation materials, anti-corrosion agents, drag-reducing agents, etc. The amount and character of the fibers used in the treatment fluid may depend upon the particular application and use. Typically, the amount of fibers may be used in the treatment fluids anywhere from about 0.5 g/L to about 50 g/L.

While the previous discussion has been directed to the use of degradable high temperature polymer fibers such as polyamines, polyesters, etc., other materials may be used in degradable fiber systems. In particular, degradable biopolymer fiber systems may be used in downhole applications. Such biopolymer fibers include those formed from polycarbohydrate or cellulose and protein fibers. These may be used at lower temperature ranges, such as from about 0° C. to about 95° C., with the use of enzymes, and at higher temperatures of from about 95° C. to about 200° C. or higher without the use of enzymes. In particular, the use of biopolymers have application at low temperatures of from about 35° C. to about 85° C. and at high temperatures of from about 120° C. to about 205° C.

Natural polymers may be used as the biopolymer. These may include cellulose-based and protein-based polymers. Cellulose-based fibers may include viscose fiber (e.g. Rayon, Liocell, etc.), cellulose fiber made from wood, cotton, hemp, etc., or other naturally occurring cellulosic materials, cellophane, etc. Combinations of different cellulose materials may also be used.

Proteins may be used as the biopolymers. Protein-based fibers may include milk or casein fibers, soy protein fibers, natural silk, etc.

At low temperatures or where degradation of the biopolymer fibers through temperature alone is insufficient, enzymes are employed with the biopolymer fibers. The enzymes may be cellulases. The cellulases may be cellulases themselves, hemi-cellulases, endo-cellulases and exo-cellulases. The enzymes may also be proteases. Combinations of different enzymes may also be used.

The biopolymer fibers may be used in the treatment fluid in an amount suitable to carry out the function and purpose of the degradable fiber component. In certain embodiments, the biopolymer fibers may be used in an amount of from about 0.5 g/L about 18 g/L of treatment fluid, more particularly from about 2, 2.5, or 3 g/L to about 10, 11 or 12 g/L of treatment fluid.

The enzymes are used in combination with the biopolymer fibers in amounts sufficient to affect the degradation of the biopolymer. In certain applications, the enzymes are used in an amount of from about 0.01 to about 2.5 grams of enzymes per liter of treatment fluid, more particularly from about 0.1 to about 0.6 grams of enzymes per liter of treatment fluid.

The enzymes may be used as free enzymes, used in granular form or they may be encapsulated, including multiple encapsulation. They may be impregnated or otherwise incorporated into or with the biopolymer itself.

The fibers and enzymes may be delivered downhole separately, mixed as a batch or on-the-fly.

The fiber/enzyme system may be used with other components and additives, such as enzyme stabilizers, such as salts and surfactants, which may be mixed with the enzymes.

The degradable biopolymer fiber systems may be used in the same manner to the fiber systems previously described. In certain applications, the biopolymer fibers with and without enzymes may be used in well stimulation, such as fracturing and acidizing treatments. It may be used with drilling fluids, such as a fluid loss additive. The fibers and enzymes may be each be pumped separately, such as through bullhead, coil, etc. They may be mixed on the fly or in a batch and pumped together. The fibers and enzymes may be mixed on location or may be premixed and stored off location for later transportation and use.

The following examples serve to further illustrate the invention.

### EXAMPLES

### Experimental For Examples 1-6

The following procedures were used for Examples 1-6. All of the samples were tested in deionized water with a water/fiber weight ratio of 10/1. The fibers used were nylon 6 fibers approximately 3 mm long and 12 μm thick. The samples were aged in hermetic glass bottles placed in an oven. At regular intervals, the samples were taken out of the oven, the mix filtered and the fibers dried in an oven at 50° C. and 0% relative humidity (RH) for 12 hours. The filtered and dried fibers were then weighed and compared to the original weight of the fibers to measure the rate of degradation. If necessary, the fibers were put back in the filtrate for further aging.

### Comparative Example 1

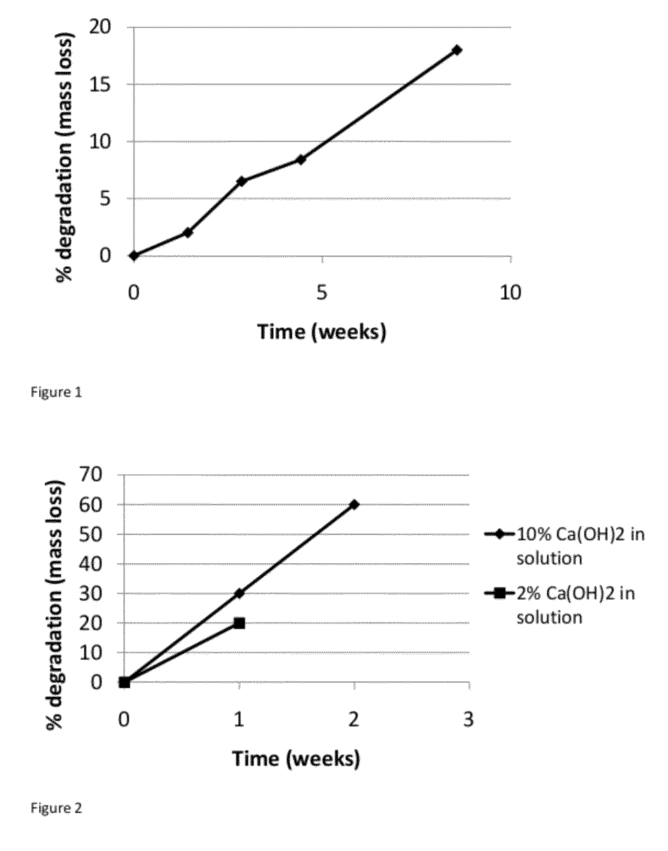

Approximately 2 g of pure nylon 6 fibers in 20 g of DI water were tested at 130° C. without the use of any fiber degrading accelerant. The results are presented in FIG. 1.

### Example 2

Nylon 6 fibers were tested at 130° C. in conjunction with different amounts of Ca(OH)₂ powder to provide the fluid with approximately 2% and 10% by weight Ca(OH)₂. Table 1 below sets for the amounts of fiber and fiber degrading accelerant used in each case. The results are presented in FIG. 2.

TABLE 1

| Compound | Experiment 1 | Experiment 2 |
|---|---|---|
| Nylon 6 fibers | 2 g | 2 g |
| Ca(OH)₂ powder | 2 g | 0.4 g |
| DI water | 18 g | 18 g |

### Example 3

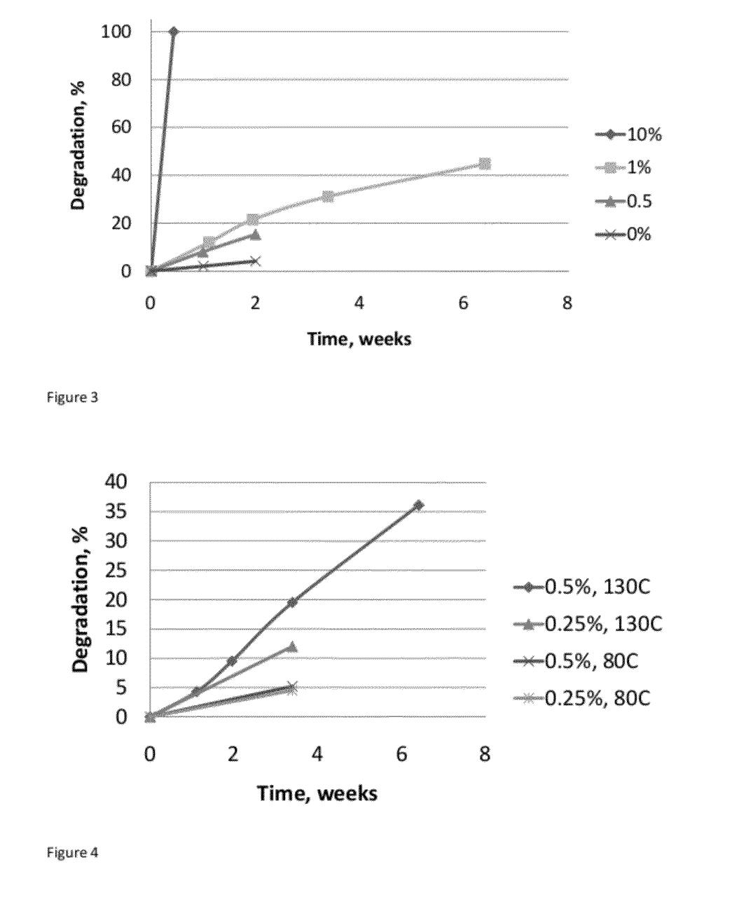

Nylon 6 fibers were tested at 130° C. in conjunction with different amounts of benzoic acid to provide the fluid with 0%, 0.5%, 2% and 10% by weight benzoic acid. Table 2 below sets for the amounts of fiber and fiber degrading accelerant used in each case. The results are presented in FIG. 3.

TABLE 2

| Compound | Experiment 1 | Experiment 2 | Experiment 3 |
|---|---|---|---|
| Nylon 6 fibers | 2 g | 2 g | 2 g |
| Benzoic acid | 2 g | 0.2 g | 0.1 g |
| DI water | 18 g | 18 g | 18 g |

### Example 4

Nylon 6 fibers were tested at 80° C. and 130° C. in conjunction with different amounts of encapsulated NaBrO₃ to provide the fluids with approximately 0.25% and 0.5% by weight of NaBrO₃. The encapsulated NaBrO₃ was 70% active NaBrO3 encapsulated with a coating of vinylidene chloride/methylacrylate copolymer having a particle size of 18/40 mesh (0.42 mm/1 mm). Table 3 below sets for the amounts of fiber and fiber degrading accelerant used in each case. The results are presented in FIG. 4.

TABLE 3

| Compound | Experiment 1: 0.5% | Experiment 2: 0.25% |
|---|---|---|
| Nylon 6 fibers | 2 g | 2 g |
| Encapsulated NaBrO₃ | 0.1 g | 0.05 g |
| DI water | 18 g | 18 g |

### Example 5

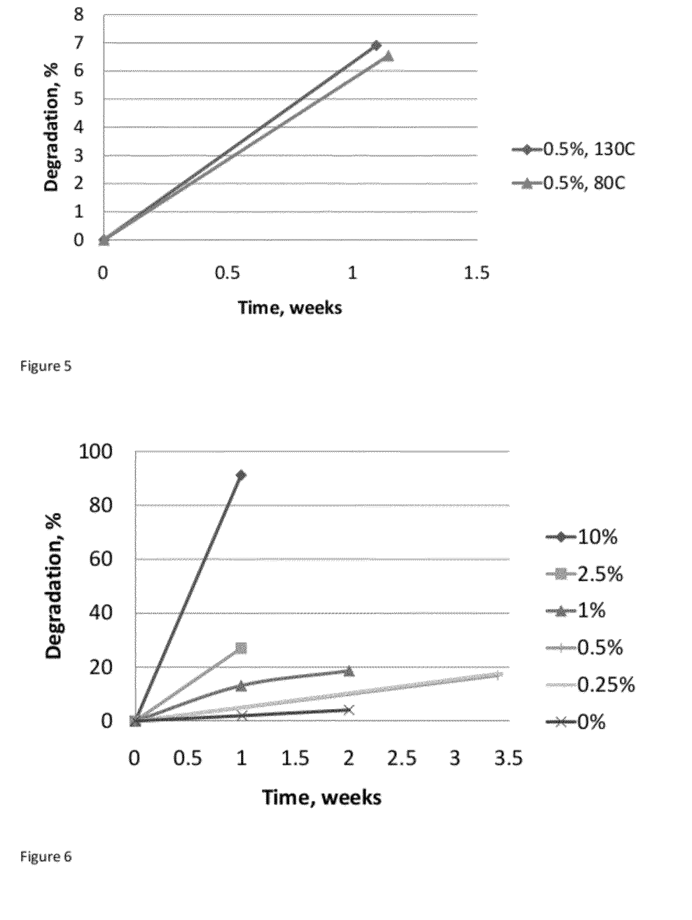

Nylon 6 fibers were tested at 80° C. and 130° C. in conjunction with encapsulated sodium persulfate to provide the fluids with approximately 0.5% by weight of sodium persulfate. The encapsulated sodium persulfate was 80% active sodium persulfate with a coating of vinylidene chloride/methylacrylate copolymer having a particle size of 20/40 mesh (0.84 mm/1 mm). Table 4 below sets for the amounts of fiber and fiber degrading accelerant used in each case. The results are presented in FIG. 5.

TABLE 4

| Compound | Experiment 1: 0.5% |
|---|---|
| Nylon 6 fibers | 2 g |
| Encapsulated Sodium Persulfate | 0.1 g |
| DI water | 18 g |

### Example 6

Nylon 6 fibers were tested at 130° C. in conjunction with different polylactic acid (PLA) materials. Two forms of PLA were used to provide the fluids with approximately 0%, 0.25%, 0.5%, 1%, 2.5% and 10% by weight of PLA. These included PLA beads in the form of 3 mm spherical particles and PLA fibers approximately 6 mm long and 12 μm thick. Table 5 below sets for the amounts of fiber and fiber degrading accelerant used in each case. The results are presented in FIG. 6.

TABLE 5

| | Exp. 1 | Exp. 2 | Exp. 3 | Exp. 4 | Exp. 5 |
|---|---|---|---|---|---|
| Compound | 10% | 2.5% | 1% | 0.5% | 0.25% |
| Nylon 6 fibers | 2 g | 2 g | 2 g | 2 g | 2 g |
| PLA | 2 g, | 0.5 g, | 0.2 g, | 0.1 g ,fibers | 0.05 g, fibers |
| | beads | beads | beads | | |
| DI water | 18 g | 18 g | 18 g | 18 g | 18 g |

### Example 7

Various cellulose-based fibers at a concentration of 40 lbs/1000 gal (4.79 g/L) were placed in 100 mL of water with cellulase enzyme at 2 lbs/1000 gal (0.24 g/L). The cellulase enzyme was TsellLyuks-A, available from Ltd. PO SIBBIOFARM, Novosibirsk, Russia, which is an enzyme containing cellulases. The samples were heated for 5 days at 120° F. (48.9° C.) in an oven. The residues were filtered off, washed with deionized water, dried at 100° F. (37.8° C.) and weighed. The results are presented in FIG. 7.

### Example 8

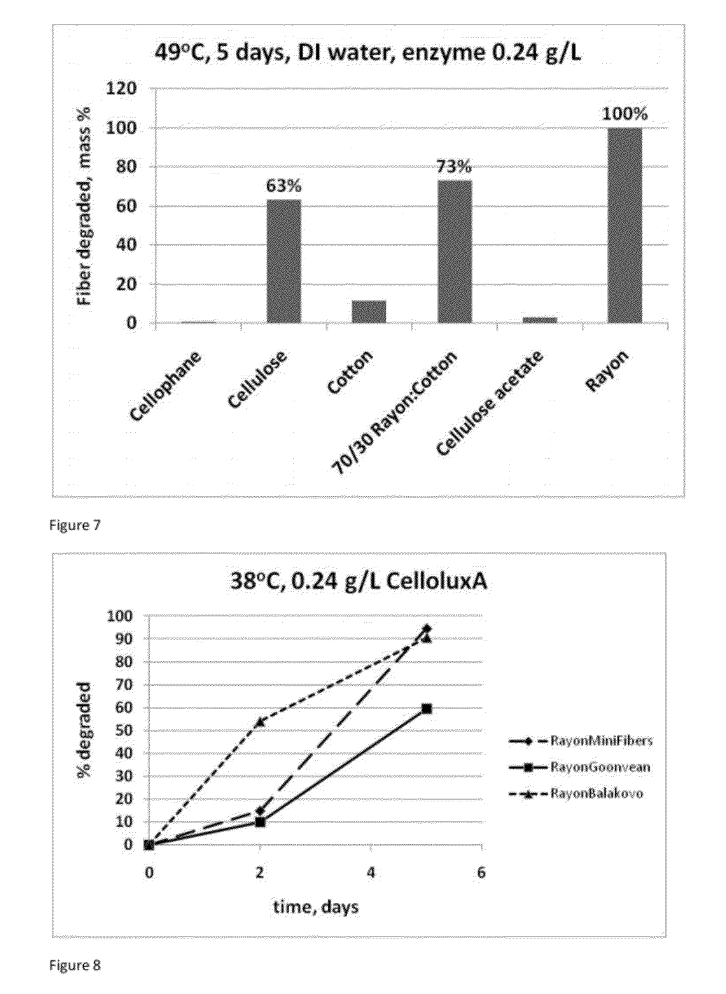

Various Rayon fibers were tested. These included those Rayon fibers from various manufacturers: MiniFibers Rayon fibers at approximately 6 mm long and 12 μm diameter; Goonvean Rayon fibers at 10 mm long and 40-50 μm diameter; and Balakovo (Russia) Rayon fibers at 6 mm long and 10-12 μm diameter. The Rayon fibers were used at a concentration of 40 lbs/1000 gal (4.79 g/L) in 100 mL of water with cellulase enzyme at 2 lbs/1000 gal (0.24 g/L). The cellulase enzyme was CelloLux-A. The samples were heated for 2 days and 5 days at 100° F. (37.8° C.) in an oven. The residues were filtered off, washed with deionized water, dried at 100° F. (37.8° C.) and weighed. The results are presented in FIG. 8.

### Example 9

Fresh CelloLux-A enzyme and CelloLux-A that was kept for 24 hours in a NaOH solution at a pH of 9 and was added to 40 lbs/1000 gal (4.79 g/L) of Rayon fibers. The fresh enzyme at 2 lbs/1000 gal (0.24 g/L) was added to the Rayon fibers at a neutral pH (pH=7). Fresh enzyme at 2 lbs/1000 gal (0.24 g/L) was also added to 40 lbs/1000 gal (4.79 g/L) of Rayon fibers at a pH of 9. The enzyme that was kept for 24 hours at a pH of 9 was also added at 2 lbs/1000 gal (0.24 g/L) to 40 lbs/1000 gal (4.79 g/L) of Rayon fibers. The samples were heated for 3 days at 120° F. (48.9° C.) in an oven. The residues were filtered off, washed with deionized water, dried at 100° F. (37.8° C.) and weighed. The results are presented in FIG. 9. As shown in FIG. 9, the sample at a pH of 9 did not degrade, indicating that the enzyme was not working. The enzyme that was kept at a pH of 9, however, when used at the neutral pH did degrade, indicating that this effect is reversible by adjusting the pH.

### Example 10

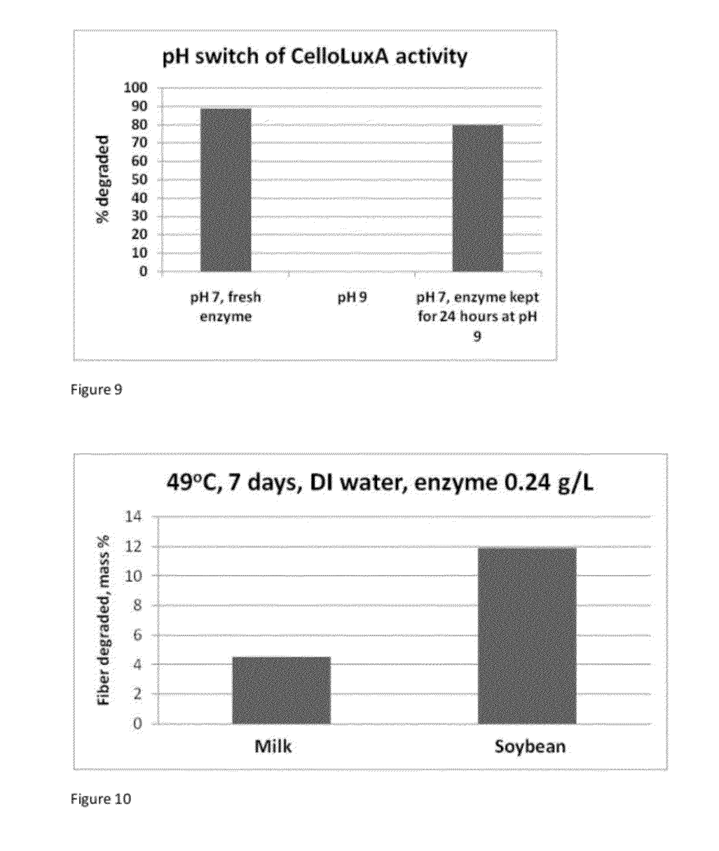

Different protein-based fibers (milk and soybean) at a concentration of 40 lbs/1000 gal (4.79 g/L) each were placed in 100 mL of water with protease enzyme at 2 lbs/1000 gal (0.24 g/L). The protease enzyme was Protosubtilin G3x, available from Ltd. PO SIBBIOFARM, Novosibirsk, Russia, which is an enzyme containing proteases. The samples were heated for 7 days at 120° F. (48.9° C.) in an oven. The residues were filtered off, washed with deionized water, dried at 100° F. (37.8° C.) and weighed. The results are presented in FIG. 10.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. A method of treating a subterranean formation penetrated by a wellbore, the method comprising:
introducing a treatment fluid into the formation through the wellbore wherein the formation has a formation temperature of at least 70° C., the treatment fluid comprising:
water;
fibers formed from high temperature polymers of at least one of a polyester, polyamide, polyurethane, polyurea, and copolymers of these, wherein the high temperature polymers do not substantially degrade in water at a pH of about 5 to about 9 at temperatures below 80° C.; and
a fiber degrading accelerant that facilitates degrading the fibers at the formation temperature.

2. The method of claim 1, wherein the high temperature polymers are selected from at least one of nylon 6, nylon 6,6, nylon 6,12, nylon 11, polypeptides, polyurethane, polyurea, polyethylene terephtalate, polyhydroxycarboxylic acids, polyaminoacids, and copolymers of these.

3. The method of claim 1, wherein the fiber degrading accelerant is formed from a material that is mixed in the treatment fluid with the fibers and that releases the fiber degrading accelerant within the treatment fluid over a period of at least one hour when at the formation temperature.

4. The method of claim 1, wherein the fiber degrading accelerant is incorporated with at least some of the fibers.

5. The method of claim 1, wherein the fiber degrading accelerant is encapsulated within an encapsulating material.

6. The method of claim 1, wherein the fiber degrading accelerant is formed as a degrading polymer that degrades at the formation temperature.

7. The method of claim 1, wherein the fiber degrading accelerant is formed as a degrading polymer that readily degrades at the formation temperature to release fiber degrading materials, the degrading polymer being coextruded with the high temperature polymers to form the fibers.

8. The method of claim 1, wherein the fiber degrading accelerant forms a core of the fibers, with the high temperature polymers surrounding the core.

9. The method of claim 1, wherein the fiber degrading accelerant comprises a base selected from at least one of calcium hydroxide, calcium oxide, magnesium hydroxide, magnesium oxide and zinc oxide.

10. The method of claim 1, wherein the fiber degrading accelerant comprises an acid selected from at least one of oleic acid, benzoic acid, nitrobenzoic acid, stearic acid, uric acid, fatty acids, and derivatives of these.

11. The method of claim 1, wherein the fiber degrading accelerant comprises an oxidizer selected from at least one of a bromate, a persulfate, a nitrate, a nitrite, a chlorite, a hypochlorite, a perchlorite, and a perborate.

12. The method of claim 1, wherein the fiber degrading accelerant comprises a polymer selected from at least one of polymers and copolymers of lactic acid, glycolic acid, vinyl chloride, phthalic acid, and combinations of these.

13. The method of claim 1, wherein the fiber degrading accelerant is used with the high temperature polymer in weight ratio of from about 1:1 to about 1:100.

14. The method of claim 1, wherein the treatment fluid further comprises a proppant.

15. The method of claim 1, wherein the fiber degrading accelerant does not form a diacid.

16. A composition for treating a well of a subterranean formation having a formation temperature of at least 70° C., the composition comprising:
water;
an amount of fibers formed from high temperature polymers of at least one of a polyester, polyamide, polyurethane, polyurea, and copolymers of these, each of said high temperature polymers being characterized by the property of not substantially degrading in water at a pH of about 5 to about 9 at temperatures below 80° C.; and
a fiber degrading accelerant that facilitates degrading of the fibers at the formation temperature.

17. The composition of claim 16, wherein the high temperature polymers are selected from at least one of nylon 6, nylon 6,6, nylon 6,12, nylon 11, polypeptides, polyurethane, polyurea, polyethylene terephtalate, polyhydroxycarboxylic acids, polyaminoacids, and copolymers of these.

18. The composition of claim 16, wherein at least one of (1) to (4), wherein:
(1) the fiber degrading accelerant is formed from a material that is mixed in the treatment fluid with the fibers and that releases the fiber degrading accelerant within the treatment fluid over a period of at least one hour when at the formation temperature;
(2) the fiber degrading accelerant is incorporated with at least some of the fibers;
(3) the fiber degrading accelerant is encapsulated within an encapsulating material; and
(4) the fiber degrading accelerant is formed as a degrading polymer that degrades at the formation temperature.

19. The composition of claim 16, wherein the fiber degrading accelerant is formed as a degrading polymer that readily degrades at the formation temperature to release fiber degrading materials, the degrading polymer being coextruded with the high temperature polymers to form the fibers.

20. The composition of claim 16, wherein the fiber degrading accelerant forms a core of the fibers, with the high temperature polymers surrounding the core.
